(19) United States
(12) Patent Application Publication
(10) Pub. No.: US 2009/0160863 A1
(43) Pub. Date: Jun. 25, 2009

(54) Unified Processor Architecture For Processing General and Graphics Workload

(76) Inventor: Michael Frank, Sunnyvale, CA (US)

Correspondence Address: MEYERTONS, HOOD, KIVLIN, KOWERT & GOETZEL (AMD), P.O. BOX 398, AUSTIN, TX, 78767-0398, US

(21) Appl. No.: 11/962,778

(22) Filed: Dec. 21, 2007

(51) Int. Cl. G06F 15/00; G06F 9/312

(52) U.S. Cl. 345/501; 712/205; 712/E09.033

(57) ABSTRACT

A processor comprising one or more control units, a plurality of first execution units, and one or more second execution units. Fetched instructions that conform to a processor instruction set are dispatched to the first execution units. Fetched instructions that conform to a second instruction set (different from the processor instruction set) are dispatched to the second execution units. The second execution units may be configured to performing graphics operations, or other specialized functions such as executing Java bytecode, managed code, video/audio processing operations, encryption/decryption operations etc. The second execution units may be configured to operate in a coprocessor-like fashion. A single control unit may handle the fetch, decode and scheduling for all the executions units. Alternatively, multiple control units may handle different subsets of the executions units.

### BACKGROUND

1. Field of the Invention

The present invention relates generally to systems and methods for performing general-purpose processing and specialized processing (such as graphics rendering) in a single processor.

2. Description of the Related Art

The current personal computer (PC) architecture has evolved from a single processor (Intel 8088) system. The workload has grown from simple user programs and operating system functions to a complex mixture of graphical user interface, multitasking operating system, multimedia applications, etc. Most PCs have included a special graphics processor, generally referred to as a GPU, to offload graphics computations from the CPU, allowing the CPU to concentrate on control-intensive tasks. The GPU is typically located on an I/O bus in the PC. In addition, the GPU has recently been used to execute massively parallel computational tasks. As a result, modern computer systems have two complex processing units that are optimally suited to different workload characteristics, each processing unit having its own programming paradigm and instruction set. In typical application scenarios, neither processing unit is fully utilized. However, each processing unit consumes a significant amount of power and board real estate.

Traditional x86 processors are not well adapted for the types of calculations performed in 3D graphics. Thus, without the assistance of graphics accelerator hardware, software applications that involve 3D graphics typically run very slowly on x86 processors. With graphics hardware acceleration, graphics processing tasks will run more quickly, however, the software application will experience a long latency when it requests for a graphics task to be performed on the accelerator since the commands/data specifying the task will have to be sent to the accelerator through the computer's software infrastructure (including operating system and the device drivers). A software application that involves a large number of small graphics tasks may experience so much overhead due to this communication latency that the graphics accelerator may be severely underutilized.

### SUMMARY

In some embodiments, a processor includes a plurality of execution units, a graphics execution unit (GEU), and a control unit. The control unit couples to the GEU and the plurality of execution units and is configured to fetch a stream of instructions from system memory (e.g., via an instruction cache). The stream of instructions includes first instructions conforming to a processor instruction set and second instructions for performing graphics operations. The processor instruction set is an instruction set that includes at least a set of general-purpose processing instructions. The “second instructions” include one or more graphics instructions. Examples of graphics instructions include an instruction for performing pixel shading on pixels, an instruction for performing geometry shading on geometric primitives, and an instruction for performing pixel shading on geometric primitives. The control unit is configured to: decode the first instructions and the second instructions; schedule execution of at least a subset of the decoded first instructions on the plurality of execution units; and schedule execution of at least a subset of the decoded second instructions on the GEU. The processor may be configured to use a unified memory space for the first instructions and the second instructions, i.e., addresses used in the first instructions and address used in the second instructions refer to the same memory space. In one embodiment, the processor also includes an interface unit and a request router. The interface unit is configured to forward the decoded second instructions to the GEU via the request router, wherein the GEU is configured to operate in coprocessor fashion. The request router may route memory access requests from the processor to system memory (or an intermediate device such as a North Bridge).

In one embodiment, the processor also includes an execution unit for executing Java bytecode. In this embodiment, the control unit is configured to identify any Java bytecode in the fetched stream of instructions and to schedule the Java bytecode for execution on this execution unit.

In another embodiment, the processor also includes an execution unit for executing managed code. In this embodiment, the control unit is configured to identify any managed code in the fetched stream of instructions and to schedule the managed code for execution on this execution unit.

In one embodiment, the GEU includes one or more of a vertex shader, a geometry shader, a rasterizer and a pixel shader.

In some embodiments, a processor includes a plurality of first execution units, one or more second execution units, a first control unit, and a second control unit. The control unit couples to the plurality of first execution units and is configured to fetch a first stream of instructions. The first stream of instructions includes first instructions conforming to a general purpose processor instruction set. The control unit is configured to decode the first instructions and schedule execution of at least a subset of the decoded Is first instructions on the plurality of execution units. The second control unit is coupled to the one or more second execution units and configured to fetch a second stream of instructions. The second stream of instructions includes second instructions conforming to a second instruction set different from the processor instruction set. The second control unit is configured to decode the second instructions and schedule execution of at least a subset of the decoded second instructions on the one or more second execution units. In one embodiment, the processor is configured so that the first instructions and the second instructions address the same memory space.

In one embodiment, the processor also includes an interface unit and a request router. The interface unit is configured to forward the decoded second instructions to the one or more second execution units via the request router. The one or more second execution units may be configured to operate as coprocessors.

In various embodiments, the second instructions may include one or more graphics instructions (i.e., instructions for performing graphics operations), Java bytecode, managed code, video processing instructions, matrix/vector math instructions, encryption/decryption instructions, audio processing instructions, or any combination of these types of instructions.

In one embodiment, at least one of the one or more second execution units includes a vertex shader, a geometry shader, a pixel shader, and a unified shader for both pixels and vertices.

In some embodiments, a processor may include a plurality of first execution units, one or more second execution units, and a control unit. The control unit is coupled to the plurality of first execution units and the one or more second execution units and configured to fetch a stream of instructions. The stream of instructions includes first instructions conforming to a processor instruction set and second instructions conforming to a second instruction set different from the processor instruction set. The control unit is further configured to decode the first instructions, schedule execution of at least a subset of the decoded first instructions on the plurality of first execution units, decode the second instructions, and schedule execution of at least a subset of the decoded second instructions on the one or more second execution units. The processor may be configured so that the first instructions and the second instructions address the same memory space.

### BRIEF DESCRIPTION OF THE DRAWINGS

A better understanding of the present invention can be obtained when the following detailed description of the preferred embodiment is considered in conjunction with the following drawings.

FIG. 1 illustrates one embodiment of a processor, having a single fetch-decode-and-schedule unit, and configured to support a unified instruction set that includes a processor instruction set and a second instruction set.

FIG. 2 illustrates one embodiment of a processor, having a single fetch-decode-and-schedule (FDS) unit, where a number of coprocessor-like execution unit are coupled to the FDS unit through an interface and a request router.

FIG. 3 illustrates a fetched stream of instructions having mixed instructions from the processor instruction set and the second instruction set (e.g., graphics instructions).

FIG. 4 illustrates one embodiment of a processor, having two fetch-decode-and-schedule (FDS) units, i.e., a first FDS unit for decoding instructions targeting a first set of execution units, and second FDS unit for decoding instructions targeting a second set of execution units.

FIG. 5 illustrates one embodiment of a processor, having two fetch-decode-and-schedule (FDS) units, wherein a number of coprocessor-like execution unit are coupled to one of the FDS units through an interface and a request router.

FIG. 6 illustrates an example of the first and second instruction streams that are fetched by the two FDS units, respectively.

FIG. 7 illustrates one embodiment of a graphics execution unit (GEU).

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

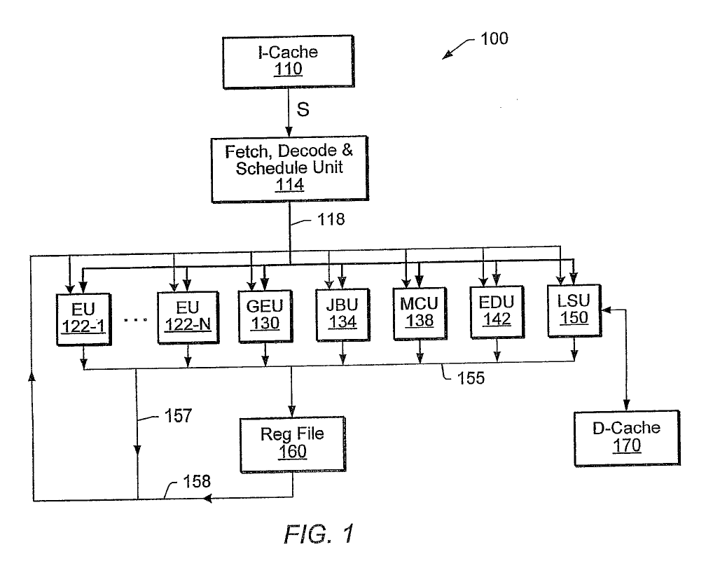

FIG. 1 illustrates one embodiment of a processor 100. Processor 100 includes an instruction cache 110, a fetch-decode-and-schedule (FDS) unit 114, execution units 122-1 through 122-N (where N is a positive integer), a load/store unit 150, a register file 160, and a data cache 170. Furthermore, the processor 100 includes one or more additional execution units, e.g., one or more of the following: a graphics execution unit (GEU) 130 for performing graphics operations; a Java bytecode unit (JBU) 134 for executing Java byte code; a managed code unit (MCU) 138 for executing managed code; an encryption/decryption unit (EDU) 142 for performing encryption and decryption operations; a video execution unit for performing video processing operations; and a matrix math unit for performing integer and/or floating-point matrix and vector operations. In some embodiments, the JBU 134 and the MCU 138 may not be included. Instead, the Java byte code and/or managed code may be handled within the FDS unit 114. For example, the FDS unit 114 may decode the Java byte code or managed code into instructions in the general purpose processor instruction set, or may decode them into calls to microcode routines.

Java bytecode is the form of instructions executed by the Java Virtual Machine as defined by Sun Microsystems, Inc. Managed code is the form of instructions executed by Microsoft's CLR Virtual Machine.

The instruction cache 110 stores copies of instructions that have been recently accessed from system memory. (System memory resides external to processor 100.) FDS unit 114 fetches a stream S of instructions from the instruction cache 110. The instructions of the stream S are instructions drawn from a unified instruction set U that is supported by the processor 100. The unified instruction set includes (a) the instructions of a processor instruction set P and (b) the instructions of a second instruction set Q distinct from the processor instruction set P.

As used herein, the term “processor instruction set” is any instruction set that includes at least a set of general-purpose processing instructions such as instructions for performing integer and floating-point arithmetic, logic operations, bit manipulation, branching and memory access. A “processor instruction set” may also include other instructions, e.g., instructions for performing simultaneous-instruction multiple-data (SIMD) operations on integer vectors and/or on floating point vectors.

In some embodiments, the processor instruction set P may include an x86 instruction set such as the IA-32 instruction set from Intel or the AMD-64^{TM} instruction set defined by AMD. In other embodiments, the processor instruction set P may include the instruction set of a processor such as a MIPS processor, a SPARC processor, an ARM processor, a PowerPC processor, etc. The processor instruction set P may be defined in an instruction set architecture.

In one embodiment, the second instruction set Q includes a set of instructions for performing graphics operations. In another embodiment, the second instruction set Q includes Java bytecode. In yet another embodiment, the second instruction set Q includes managed code. More generally, the second instruction set Q may include one or more instructions sets, e.g., one or more of the following: a set of instructions for performing graphics operations; Java bytecode; managed code; a set of instructions for performing encryption and decryption operations; a set of instructions for performing video processing operations; and a set of instructions for performing matrix and vector arithmetic. Various embodiments corresponding to different combinations of one or more of these instructions sets are contemplated.

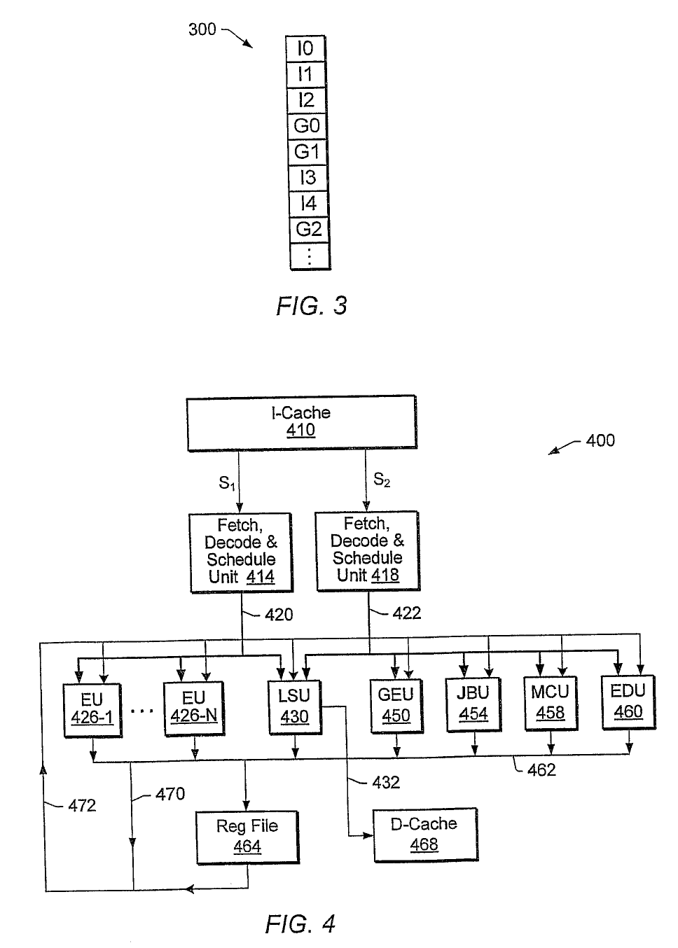

The programmer has the freedom to intermix instructions of the processor instruction set P and the instructions of the second instruction set Q when building a program for processor 100. Thus, the stream S of fetched instructions may include a mixture of instructions from the processor instruction set P and the second instruction set Q. An example of this mixing of instructions within stream S is illustrated by FIG. 3 in the special case where the second instruction set Q is a set of graphics instructions. Example stream 300 includes instructions I0, I1, I3, . . . from the processor instruction set P, and instructions G0, G1, G2, . . . from the second instruction set Q. In another embodiment, the processor 100 may implement multithreading (or hyperthreading). Each thread may include mixed instructions, or may include instructions from one of the source instruction sets P and Q.

As noted above, in some embodiments, the second instruction set Q may include a set of instructions for performing graphics operations. For example, the second instruction set Q may include instructions for performing vertex shading on vertices, instructions for performing geometry shading on geometric primitives (such as triangles), instructions for performing rasterization of geometric primitives, and instructions for performing pixel shading on pixels. In one embodiment, the second instruction set Q may include a set of instructions conforming to the Direct3D10 API. (“API” is an acronym for “application programming interface” or “application programmer's interface”.) In another embodiment, the second instruction set Q may include a set of instructions conforming to the OpenGL API.

FDS unit 114 decodes the stream of fetched instructions into executable operations (ops). Each fetched instruction is decoded into one or more ops. Some of the fetched instructions (e.g., some of the more complex instructions) may be decoded by accessing a microcode ROM. Furthermore, some of the fetched instructions may be decoded in a one-to-one fashion, i.e., so that the instruction results in a single op that is unique to that instruction. For example, some of the fetched instructions may be decoded so that the resulting op is identical (or similar) to the fetched instruction. In one embodiment, graphics instructions, Java byte code, managed code, encryption/decryption code and floating-point instructions may be decoded to generate a single op per instruction in a one-to-one fashion.

The FDS unit 114 schedules the ops for execution on the execution units including: the execution units 122-1 through 122-N, the one or more additional execution units, and load/store unit 150. In those embodiments that include GEU 130, the FDS unit 114 identifies any graphics instructions (of the second instruction set Q) in the stream S and schedules the graphics instructions (i.e., the ops that result from decoding the graphics instructions) for execution in GEU 130.

In those embodiments that include JBU 134, the FDS unit 114 identifies any Java bytecode in the stream S of fetched instructions and schedules the Java bytecode for execution in JBU 134.

In those embodiments that include MCU 138, the FDS unit 114 identifies any managed code in the stream S of fetched instructions and schedules the managed code for execution in MCU 138.

In those embodiments that include EDU unit 142, the FDS unit 114 identifies any encryption or decryption instructions in the stream S of fetched instructions and schedules these instructions for execution in EDU unit 142.

As noted above, the FDS unit 114 decodes each instruction of the stream S of fetched instructions into one or more ops and schedules the one or more ops for execution on appropriate ones of the executions units. In some embodiments, the FDS unit 114 is configured for superscalar operation, out-of-order (OOO) execution, multi-threaded execution, speculative execution, branch prediction, or any combination thereof. Thus, in various embodiments, FDS unit 114 may include various combinations of: logic for determining the availability of the execution units; logic for dispatching two or more ops in parallel (in a given clock cycle) whenever two or more execution units capable of handling those ops are available; logic for scheduling the out-of-order execution of ops and guaranteeing the in-order retirement of ops; logic for performing context switching between multiple threads and/or multiple-processes; logic to generate traps on undefined instructions specific to the currently executing type of code; etc.

Load/store unit 150 couples to data cache 170 and is configured to perform memory write and memory read operations. For a memory write operation, the load/store unit 150 may generate a physical address and the associated write data. The physical address and write data may be entered into a store queue (not shown) for later transmission to the data cache 170. Memory read data may be supplied to load/store unit 150 from data cache 170 (or from an entry in the store queue in the case of a recent store).

Execution units 122-1 through 122-N may include one or more integer pipelines and one or more floating-point units. The one or more integer pipelines may include resources for performing integer operations (such as add, subtract, multiply and divide), logic operations (such as AND, OR, and negate), and bit manipulation (such as shift and cyclic shift). In some embodiments, resources of the one or more integer pipelines are operable to perform SIMD integer operations. The one or more floating-point units may include resources for performing floating-point operations. In some embodiments, the resources of the one or more floating-point units are operable to perform SIMD floating-point operations.

In one set of embodiments, the execution units 122-1 through 122-N include one or more SIMD units configured for performing integer and/or floating point SIMD operations.

As illustrated by FIG. 1, the execution units may couple to a dispatch bus 118 and a results bus 155. The execution units receive ops from the FDS unit 114 via the dispatch bus 118, and pass the results of execution to register file 160 via results bus 155. The register file 160 couples to feedback path 158, which allows data from the register file 160 to be supplied as source operands to the execution unit. Bypass path 157 couples between results bus 155 and feedback path, allowing the results of execution to bypass the register file 160, and thus, to be supplied as source operands to the execution units more directly. Register file 160 may include physical storage for a set of architected registers.

As noted above, the execution units 122-1 through 122-N may include one or more floating-point units. Each floating-point unit may be configured to execute floating-point instructions (e.g., x87 floating-point instructions, or floating-point instructions compliant with IEEE 754/854). Each floating-point unit may include an adder unit, a multiplier unit, a divide/square-root unit, etc. Each floating-point unit may operate in a coprocessor-like fashion, in which FDS unit 114 directly dispatches the floating-point instructions to the floating-point unit. The floating-point unit may include storage for a set of floating-point registers (not shown).

As described above, the processor 100 supports the unified instruction set U, which includes the processor instruction set P and the second instruction set Q. The unified instruction set U is defined so that the instructions of processor instruction set P (hereinafter the “P instructions”) and the instructions of the second instruction set Q (hereinafter the “Q instructions”) address the same memory space. Thus, it is easy for a programmer to build a program where the P portions of the program communicate quickly with the Q portions of the program. For example, a P instruction can write to a memory location (or register of register file 160) and a subsequent Q instruction can read from that memory location (or register). Because the program is executed on a single processor (i.e., processor 100), there is no need to invoke the facilities of the operating system in order to communicate between the P portions and the Q portions of the program.

As noted above, the programmer may freely intermix P instructions and Q instructions when building a program for processor 100. The programmer may order the instructions from the unified instruction set U to increase execution efficiency, e.g., to keep as many execution units working in parallel as possible.

In one embodiment, processor 100 may be configured on a single integrated circuit. In another embodiments, processor 100 may include a plurality of integrated circuits.

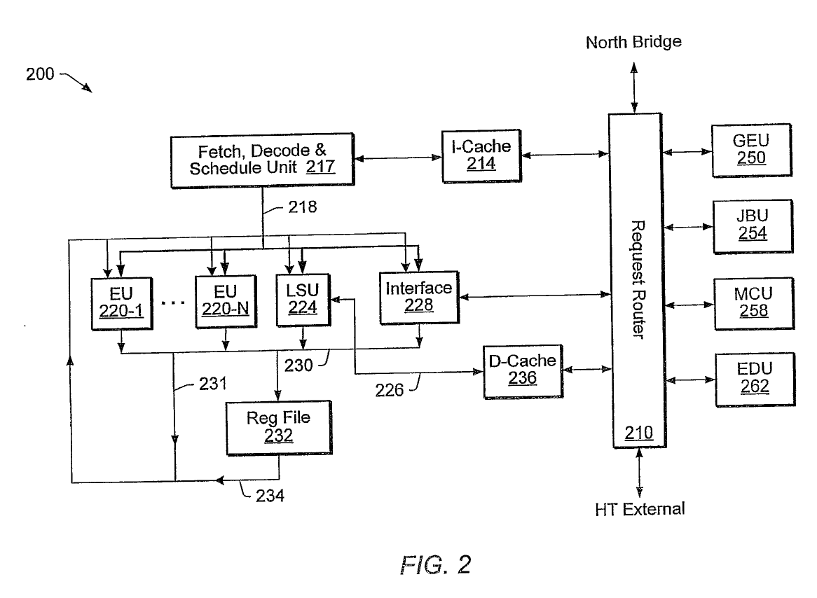

### FIG. 2

FIG. 2 illustrates one embodiment of a processor 200. Processor 200 includes a request router 210, an instruction cache 214, a fetch-decode-and-schedule (FDS) unit 217, execution unit 220-1 through 220-N, a load/store unit 224, an interface 228, a register file 232, and a data cache 236. Furthermore, the processor 200 includes one or more additional execution units, e.g., one or more of the following: a graphics execution unit (GEU) 250 for performing graphics operations; a Java bytecode unit (JBU) 254 for executing Java byte code; a managed code unit (MCU) 258 for executing managed code; an encryption/decryption unit (EDU) 262 for performing encryption and decryption operations; a video execution unit for performing video processing operations; and a matrix math unit for performing integer and/or floating-point matrix and vector operations. In some embodiments, the JBU 254 and the MCU 258 may not be included. Instead, the Java byte code and/or managed code may be handled within the FDS unit 217. For example, the FDS unit 217 may decode the Java byte code or managed code into instructions in the general purpose processor instruction set, or may decode them into calls to microcode routines.

Request router 210 couples to instruction cache 214, interface 228, data cache 236, and the one or more additional execution units (such as GEU 250, JBU 254, MCU 258 and EDU 262). Furthermore, request router 210 is configured for coupling to one or more external buses. For example, request router 210 may be configured for coupling to a frontside bus to facilitate communication with a North Bridge. In some embodiments, the request router may also be configured for coupling to a Hypertransport (HT) bus.

Request router 210 is configured to route memory access requests from instruction cache 214 and data cache 236 to system memory (e.g., via the North Bridge), to route instructions from system memory to instruction cache 214, and to route data from system memory to data cache 236. In addition, request router 210 is configured to route instructions and data between interface 228 and the one or more additional execution units such as GEU 250, JBU 254, MCU 258 and EDU 262. The one or more additional execution units may operate in a “coprocessor-like” fashion. For example, an instruction may be transmitted to a given one of the additional execution units. The given unit may execute the instruction independently and return a completion indication to the interface unit 228.

Instruction cache 214 receives requests for instructions from FDS unit 217 and asserts memory access requests (for instructions ultimately from system memory) via request router 210. The instruction cache 214 stores copies of instructions that have been recently accessed from system memory.

FDS unit 217 fetches a stream of instructions from the instruction cache 214, decodes each of the fetched instructions into one or more ops, and schedules the ops for execution on the execution units (which include execution unit 220-1 through 220-N, load/store unit 224 and the one or more additional execution units). As execution units become available, the FDS unit 217 dispatches the ops to the execution units via dispatch bus 218.

In some embodiments, processor 200 is configured to support the unified instruction set U, which, as described above, includes the processor instruction set P and the second instruction set Q. Thus, the instructions of the fetched stream are drawn from the unified instruction set U. As described above, the processor instruction set P includes at least a set of general-purpose processing instructions. The processor instruction set P may also include integer and/or floating-point SIMD instructions. As described above, the second instruction set Q may include one or more instruction sets, e.g., one or more of the following: a set of instructions for performing graphics operations; Java bytecode; managed code; a set of instructions for performing encryption and decryption operations; a set of instructions for performing video processing operations; and a set of instructions for performing matrix and vector arithmetic. The stream of fetched instructions may be a mixture of instructions from the processor instruction set P and the second instruction set Q. e.g., as illustrated by FIG. 3.

As noted above, the FDS unit 217 decodes each of the fetched instructions into one or more ops. Some of the fetched instructions (e.g., some of the more complex instructions) may be decoded by accessing a microcode ROM. Furthermore, some of the fetched instructions may be decoded in a one-to-one fashion. For example, some of the fetched instructions may be decoded so that the resulting op is identical (or similar) to the fetched instruction. In some embodiments, any instructions corresponding to the one or more additional execution units may be decoded in a one-to-one fashion. In one embodiment, the graphics instructions, Java bytecode, managed code, encryption/decryption code and floating-point instructions may be decoded in a one-to-one fashion.

Furthermore, as noted above, the FDS unit 217 schedules ops for execution on the execution units. In those embodiments that include GEU 250, the FDS unit 217 identifies any graphics instructions in the stream of fetched instructions and schedules the graphics instructions (i.e., the ops that result from decoding the graphics instructions) for execution in GEU 250. The FDS unit 217 may dispatch each graphics instruction to interface 228, whence it is forwarded to GEU 250 through request router 210. In one embodiment, the GEU 250 may be configured to execute an independent, concurrent, local instruction stream from a private instruction source. The operations forwarded from the FDS unit 217 may cause specific routines within the local instruction stream to be executed.

In those embodiments that include JBU 254, the FDS unit 217 identifies any Java bytecode in the stream of fetched instructions and schedules the Java bytecode for execution in JBU 254. The FDS unit 217 may dispatch each Java bytecode to interface unit, whence it is forwarded to JBU 254 through request router 210.

In those embodiments that include MCU 258, the FDS unit 217 identifies any managed code in the stream of fetched instructions and schedules the managed code for execution in MCU 258. The FDS unit 217 may dispatch each managed code instruction to interface 228, whence it is forwarded to MCU 258 through request router 210.

In those embodiments that include EDU 262, the FDS unit 217 identifies any encryption or decryption instructions in the stream of fetched instructions and schedules these instructions for execution in EDU 262. The FDS unit 217 may dispatch each encryption or decryption instruction to interface 228, whence it is forwarded to EDU 262 through request router 210.

Each of GEU 250, JBU 254, MCU 258 and EDU 262 receives ops, executes the ops, and sends information indicating completion of ops to the interface unit 228. Each of GEU 250, JBU 254, MCU 258 and EDU 262 has it own internal registers for storing the results of execution.

As noted above, the FDS unit 217 decodes each instruction of the stream of fetched instructions into one or more ops and schedules the one or more ops for execution on the various execution units. In some embodiments, the FDS unit 217 is configured for superscalar operation, out-of-order (OOO) execution, multi-threaded execution, speculative execution, branch prediction, or any combination thereof Thus, FDS unit 217 may include: logic for monitoring the availability of the execution units; logic for dispatching two or more ops in parallel (in a given clock cycle) whenever two or more execution units capable of handling those ops are available; logic for scheduling the out-of-order execution of ops and guaranteeing the in-order retirement of ops; logic for performing context switching between multiple threads and/or multiple-processes; etc.

Load/store unit 224 couples to data cache 236 via load/store bus 226 and is configured to perform memory write and memory read operations. For a memory write operation, the load/store unit 224 may generate a physical address and the write data. The physical address and write data may be entered into a store queue (not shown) for later transmission to the data cache 236. Memory read data may be supplied to load/store unit 224 from data cache 236 (or from an entry in the store queue in the case of a recent store).

Execution units 220-1 through 220-N may include one or more integer pipelines and one or more floating-point units, e.g., as described above in connection with processor 100. In some embodiments, the execution units 220-1 through 220-N may include one or more SIMD units configured to perform integer and/or floating point SIMD operations.

As illustrated by FIG. 2, the execution units 220-1 through 220-N, load/store unit 224 and interface 228 may couple to dispatch bus 218 and results bus 230. The execution units 220-1 through 220-N, load/store unit 224 and interface 228 receive ops from the FDS unit 217 via the dispatch bus 218, and pass the results of execution to register file 232 via results bus 230. The register file 232 couples to feedback path 234, which allows data from the register file 232 to be supplied as source operands to execution units 220-1 through 220-N, load/store unit 224 and interface 228. Bypass path 231 couples between results bus 230 and feedback path 234, allowing the results of execution to bypass the register file 232, and thus, to be supplied as source operands more directely. Register file 232 may include physical storage for a set of architected registers.

As described above, the processor 200 is configured to support the unified instruction set U, which includes the processor instruction set P and the second instruction set Q. The unified instruction set U is defined so that the instructions of processor instruction set P (hereinafter the “P instructions”) and the instructions of the second instruction set Q (hereinafter the “Q instructions”) address the same memory space. Thus, it is easy for a programmer to build a program where the P portions of the program communicate quickly with the Q portions of the program. For example, a P instruction can write to a memory location (or register of register file 160) and a subsequent Q instruction can read from that memory location (or register). Because the program is executed on a single processor (i.e., processor 200), there is no need to invoke the facilities of the operating system in order to communicate between the P portions and the Q portions of the program.

As noted above, the programmer may freely intermix P instructions and Q instructions when building a program for processor 200. The programmer may order the instructions from the unified instruction set U to increase execution efficiency, e.g., to keep as many execution units working in parallel as possible.

In one embodiment, processor 200 may be configured on a single integrated circuit. In another embodiments, processor 100 may include a plurality of integrated circuits. For example, in one embodiment, request router 210 and the elements on the left of request router 210 in FIG. 2 may be configured on a single integrate circuit, while the one or more additional executions unit (shown on the right of request router 210) may be configured on one or more additional integrated circuits.

### FIG. 4

FIG. 4 illustrates one embodiment of a processor 400. Processor 400 includes an instruction cache 410, fetch-decode-and-schedule (FDS) units 414 and 418, execution units 426-1 through 426-N, a load/store unit 430, a register file 464, and a data cache 468. Furthermore, the processor 400 includes one or more additional execution units such as one or more of the following: a graphics execution unit (GEU) 450 for performing graphics operations; a Java bytecode unit (JBU) 454 for executing Java byte code; a managed code unit (MCU) 458 for executing managed code; and an encryption/decryption unit (EDU) 460 for performing encryption and decryption operations. In some embodiments, the JBU 454 and the MCU 458 may not be included. Instead, the Java byte code and/or managed code may be handled within the FDS unit 414. For example, the FDS unit 414 may decode the Java byte code or managed code into instructions in the general purpose processor instruction set, or may decode them into calls to microcode routines.

The instruction cache 410 stores copies of instructions that have been recently accessed from system memory. (System memory resides external to processor 400.) FDS unit 414 fetches a stream S₁ of instructions from the instruction cache 110 and FDS unit 418 fetches a stream S₂ of instructions from instruction cache 110. In some embodiments, the instructions of the stream S₁ are drawn from the processor instruction set P as described above, while the instructions of the stream S₂ are drawn from the second instruction set Q as described above. FIG. 6 illustrates an example 610 of the stream S₁ and an example 620 of the stream S₂. The instructions I0, I1, I2, I3, are instructions of the processor instruction set P. The instructions V0, V1, V2, V3, are instructions of the second instruction set Q.

As described above, the processor instruction set P includes at least a set of general-purpose processing instructions. The processor instruction set P may also include integer and/or floating-point SIMD instructions.

As described above, the second instruction set Q may include one or more instruction sets, e.g., one or more of the following: a set of instructions for performing graphics operations; Java bytecode; managed code; a set of instructions for performing encryption and decryption operations; a set of instructions for performing video processing operations; and a set of instructions for performing matrix and vector arithmetic.

FDS unit 414 decodes the stream S₁ of fetched instructions into executable operations (ops). Each instruction of the stream S₁ is decoded into one or more ops. Some of the instructions (e.g., some of the more complex instructions) may be decoded by accessing a microcode ROM. Furthermore, some of the instructions may be decoded in a one-to-one fashion. For example, some of the fetched instructions may be decoded so that the resulting op is identical (or similar) to the fetched instruction. In one embodiment, any floating-point instructions in the stream S₁ may be decoded in a one-to-one fashion. The FDS unit 414 schedules the ops (that result from the decoding of stream S₁) for execution on the execution units 426-1 through 426-N and load/store unit 430.

FDS unit 418 decodes the stream S₂ of fetched instructions into executable operations (ops). Each instruction of the stream S₂ is decoded into one or more ops. Some (or all) of the instructions of the stream S₂ may be decoded in a one-to-one fashion. For example, some of the fetched instructions may be decoded so that the resulting op is identical (or similar) to the fetched instruction. In one embodiment, any graphics instructions, Java byte code, managed code or encryption/decryption code in the stream S₂ may be decoded in a one-to-one fashion. The FDS unit 418 schedules the ops (that result from the decoding of stream S₂) for execution on the one or more additional execution units (such as GEU 450, JBU 454, MCU 458 and EDU 460).

In those embodiments that include GEU 450, the FDS unit 418 identifies any graphics instructions in the stream S₂ and schedules the graphics instructions (i.e., the ops that result from decoding the graphics instructions) for execution in GEU 450.

In those embodiments that include JBU 454, the FDS unit 418 identifies any Java bytecode in the stream S₂ and schedules the Java bytecode for execution in JBU 454.

In those embodiments that include MCU 458, the FDS unit 418 identifies any managed code in the stream S₂ and schedules the managed code for execution in MCU 458.

In those embodiments that include EDU unit 460, the FDS unit 418 identifies any encryption or decryption instructions in the stream S₂ and schedules these instructions for execution in EDU unit 460.

As noted above, FDS units 414 and 418 decode instructions of the streams S₁ and S₂, respectively, into ops and schedules the ops for execution on appropriate ones of the executions units. In some embodiments, FDS unit 414 is configured for superscalar operation, out-of-order (OOO) execution, multi-threaded execution, speculative execution, branch prediction, or any combination thereof. FDS unit 418 may be similarly configured. Thus, in various embodiments, FDS unit 414 and/or FDS unit 418 may include various combinations of: logic for determining the availability of the execution units; logic for dispatching two or more ops in parallel (in a given clock cycle) whenever two or more execution units capable of handling those ops are available; logic for scheduling the out-of-order execution of ops and guaranteeing the in-order retirement of ops; logic for performing context switching between multiple threads and/or multiple-processes; etc.

Load/store unit 430 couples to data cache 468 and is configured to perform memory write and memory read operations. For a memory write operation, the load/store unit 430 may generate a physical address and associated write data. The physical address and write data may be entered into a store queue (not shown) for later transmission to the data cache 468. Memory read data may be supplied to load/store unit 430 from data cache 468 (or from an entry in the store queue in the case of a recent store).

Execution units 426-1 through 426-N may include one or more integer pipelines and one or more floating-point units. The one or more integer pipelines may include resources for performing integer operations (such as add, subtract, multiply and divide), logic operations (such as AND, OR, and negate), and bit manipulation (such as shift and cyclic shift). In some embodiments, resources of the one or more integer pipelines are operable to perform SIMD integer operations. The one or more floating-point units may include resources for performing floating-point operations. In some embodiments, the resources of the one or more floating-point units are operable to perform SIMD floating-point operations.

In one set of embodiments, the execution units 426-1 through 426-N include one or more SIMD units configured for performing integer and/or floating point SIMD operations.

As illustrated by FIG. 4, the execution units 426-1 through 426-N and load/store unit 430 may couple to a dispatch bus 420 and a results bus 462. The execution units 426-1 through 426-N and load/store unit 430 receive ops from the FDS unit 414 via the dispatch bus 420, and pass the results of execution to register file 464 via results bus 462. The one or more additional units (such as GEU 450, JBU 454, MCU 458 and EDU 460) receive ops from FDS unit 418 via dispatch bus 422, and pass the results of execution to the register file via results bus 462. The register file 464 couples to feedback path 472, which allows data from the register file 464 to be supplied as source operands to the execution units (including execution units 426-1 through 426-N, load/store unit 430, and the one or more additional execution units).

Bypass path 470 couples between results bus 462 and feedback path 472, allowing the results of execution to bypass the register file 464, and thus, to be supplied as source operands to the execution units more directly. Register file 464 may include physical storage for a set of architected registers.

In some embodiments, the FDS unit 418 is configured to dispatch ops to execution units 426-1 through 426-N (or some subset of those units) in addition to the one or more additional execution units and load/store unit 430. Thus, dispatch bus 422 may couple to one or more of the execution units 426-1 through 426-N in addition to coupling to the one or more additional execution units and the load/store unit 430.

As noted above, the execution units 426-1 through 426-N may include one or more floating-point units. Each floating-point unit may be configured to execute floating-point instructions (e.g., x87 floating-point instructions, or floating-point instructions compliant with IEEE 754/854). Each floating-point unit may include an adder unit, a multiplier unit, a divide/square-root unit, etc. Each floating-point unit may operate in a coprocessor-like fashion, in which FDS unit 114 directly dispatches the floating-point instructions to the floating-point unit. The floating-point unit may include storage for a set of floating-point registers (not shown).

As described above, in some embodiments, the processor 400 supports the processor instruction set P and the second instruction set Q. It is noted that the instructions of processor instruction set P (hereinafter the “P instructions”) and the instructions of the second instruction set Q (hereinafter the “Q instructions”) address the same memory space. Thus, it is easy for a programmer to build a first program thread using P instructions and a second program thread using Q instructions where the two threads communicate quickly through system memory or internal registers (i.e., registers of the register file 464). Because the threads are executed on a single processor (i.e., processor 400), there is no need to invoke the facilities of the operating system in order to communicate between two threads.

In one embodiment, processor 400 may be configured on a single integrated circuit. In another embodiments, processor 400 may include a plurality of integrated circuits. For example, the one or more additional execution units may be realized in one or more integrated circuits.

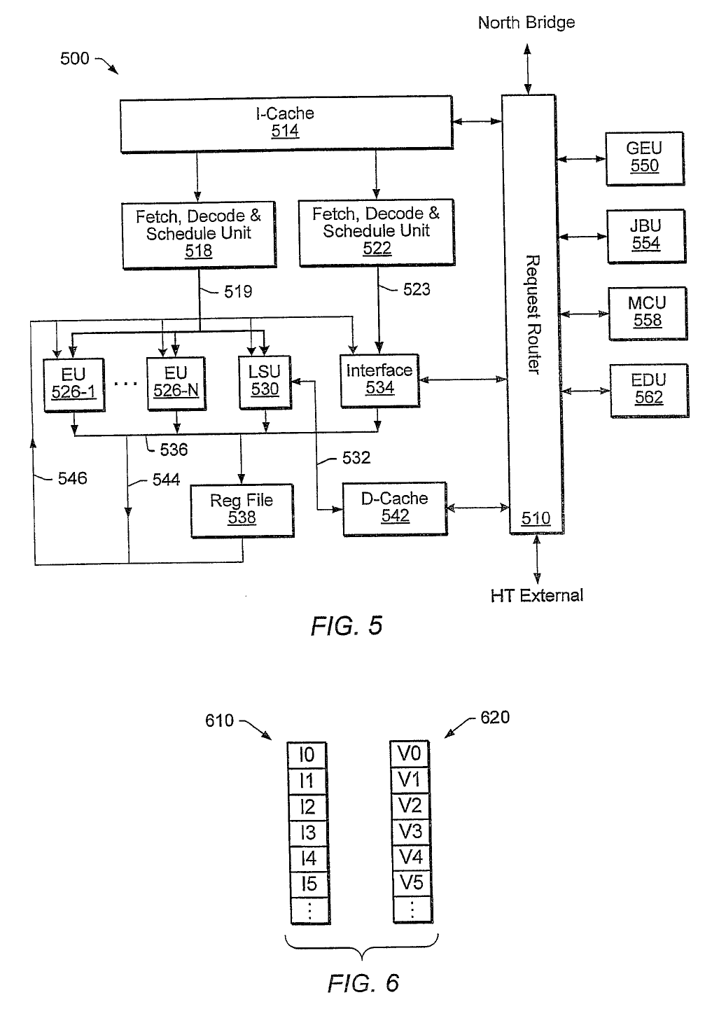

### FIG. 5

FIG. 5 illustrates one embodiment of a processor 500. Processor 500 includes a request router 510, an instruction cache 514, fetch-decode-and-schedule (FDS) units 518 and 522, execution units 526-1 through 526-N, a load/store unit 530, an interface 534, a register file 538, and a data cache 542. Furthermore, the processor 500 includes one or more additional execution units such as one or more of the following: a graphics execution unit (GEU) 550 for performing graphics operations; a Java bytecode unit (JBU) 554 for executing Java byte code; a managed code unit (MCU) 558 for executing managed code; and an encryption/decryption unit (EDU) 562 for performing encryption and decryption operations. In some embodiments, the JBU 554 and the MCU 558 may not be included. Instead, the Java byte code and/or managed code may be handled within the FDS unit 518. For example, the FDS unit 518 may decode the Java byte code or managed code into instructions in the general purpose processor instruction set, or may decode them into calls to microcode routines.

Request router 510 couples to instruction cache 514, interface 534, data cache 542, and the one or more additional execution units (such as GEU 550, JBU 554, MCU 558 and EDU 562). Furthermore, request router 510 is configured for coupling to one or more external buses. For example, the request router 510 may be configured for coupling to a frontside bus to facilitate communication with a North Bridge. In some embodiments, the request router may also be configured for coupling to a Hypertransport (HT) bus.

Request router 510 is configured to route memory access requests from instruction cache 514 and data cache 542 to system memory (e.g., via the North Bridge), to route instructions from system memory to instruction cache 514, and to route data from system memory to data cache 542. In addition, request router 510 is configured to route instructions and data between interface 534 and the one or more additional execution units (such as GEU 550, JBU 554, MCU 558 and EDU 562). The one or more additional execution units may operate in a “coprocessor-like” fashion.

The instruction cache 514 stores copies of instructions that have been recently accessed from system memory. (System memory resides external to processor 500.) FDS unit 518 fetches a first stream of instructions from the instruction cache 514 and FDS unit 522 fetches a second stream of instructions from instruction cache 514. In some embodiments, the instructions of the first stream are drawn from the processor instruction set P as described above, while the instructions of the second stream are drawn from the second instruction set Q as described above. FIG. 6 illustrates an example 610 of the first stream and an example 620 of the second stream. The instructions I0, I1, 12, 13, are instructions of the processor instruction set P. The instructions V0, V1, V2, V3, are instructions of the second instruction set Q.

As described above, the processor instruction set P includes at least a set of general-purpose processing instructions. The processor instruction set P may also include integer and/or floating-point SIMD instructions.

As described above, the second instruction set Q may include one or more instruction sets, e.g., one or more of the following: a set of instructions for performing graphics operations; Java bytecode; managed code; a set of instructions for performing encryption and decryption operations; a set of instructions for performing video processing operations; and a set of instructions for performing matrix and vector arithmetic.

FDS unit 518 decodes the first stream of fetched instructions into executable operations (ops). Each instruction of the first stream is decoded into one or more ops. Some of the instructions (e.g., some of the more complex instructions) may be decoded by accessing a microcode ROM. Furthermore, some of the instructions may be decoded in a one-to-one fashion. For example, some of the fetched instructions may be decoded so that the resulting op is identical (or similar) to the fetched instruction. In one embodiment, any floating-point instructions in the first stream may be decoded in a one-to-one fashion. The FDS unit 518 schedules the ops (resulting from the decoding of the first stream) for execution on the execution units 526-1 through 526-N and load/store unit 430.

FDS unit 522 decodes the second stream of fetched instructions into executable operations (ops). Each instruction of the second stream is decoded into one or more ops. Some (or all) of the instructions of the second stream may be decoded in a one-to-one fashion. For example, in one embodiment, any graphics instructions, Java byte code, managed code or encryption/decryption code in the second stream may be decoded in a one-to-one fashion. The FDS unit 522 schedules the ops (resulting from the decoding of the second stream) for execution on the one or more additional execution units (such as GEU 550, JBU 554, MCU 558 and EDU 562). The FDS 522 dispatches ops to the one or more additional execution units via dispatch bus 523, interface unit 534 and request router 510.

In those embodiments that include GEU 550, the FDS unit 522 identifies any graphics instructions in the second stream and schedules the graphics instructions (i.e., the ops that results from decoding the graphics instructions) for execution in GEU 550. The FDS unit 522 may dispatch each graphics instruction to interface 534, whence it is forwarded to GEU 550 through request router 510.

In those embodiments that include JBU 554, the FDS unit 522 identifies any Java bytecode in the second stream and schedules the Java bytecode for execution in JBU 554. The FDS unit 522 may dispatch each Java bytecode instruction to interface 534, whence it is forwarded to JBU 554 through request router 510.

In those embodiments that include MCU 558, the FDS unit 522 identifies any managed code in the second stream and schedules the managed code for execution in MCU 558. The FDS unit 522 may dispatch each managed code instruction to interface 534, whence it is forwarded to MCU 558 through request router 510.

In those embodiments that include EDU unit 562, the FDS unit 522 identifies any encryption or decryption instructions in the second stream and schedules these instructions for execution in EDU unit 562. The FDS unit 522 may dispatch each encryption or decryption instruction to interface 534, whence it is forwarded to EDU 562 through request router 510.

Each of the one or more additional execution units (such as GEU 550, JBU 554, MCU 558 and EDU 562) receives ops, executes the ops, and returns information indicating completion of the ops to interface 534 via request router 510.

As noted above, FDS units 518 and 522 decode instructions of the first and second streams into ops and schedule the ops for execution on appropriate ones of the executions units. In some embodiments, FDS unit 518 is configured for superscalar operation, out-of-order (OOO) execution, multi-threaded execution, speculative execution, branch prediction, or any combination thereof. FDS unit 522 may be similarly configured. Thus, in various embodiments, FDS unit 518 and/or FDS unit 522 may include various combinations of: logic for determining the availability of the execution units; logic for dispatching two or more ops in parallel (in a given clock cycle) whenever two or more execution units capable of handling those ops are available; logic for scheduling the out-of-order execution of ops and guaranteeing the in-order retirement of ops; logic for performing context switching between multiple threads and/or multiple-processes; etc.

Load/store unit 530 couples to data cache 542 and is configured to perform memory write and memory read operations. For a memory write operation, the load/store unit 530 may generate a physical address and associated write data. The physical address and write data may be entered into a store queue (not shown) for later transmission to the data cache 542. Memory read data may be supplied to load/store unit 530 from data cache 542 (or from an entry in the store queue in the case of a recent store).

Execution units 526-1 through 526-N may include one or more integer pipelines and one or more floating-point units. The one or more integer pipelines may include resources for performing integer operations (such as add, subtract, multiply and divide), logic operations (such as AND, OR, and negate), and bit manipulations (such as shift and cyclic shift). In some embodiments, the resources of the one or more integer pipelines are operable to perform SIMD integer operations. The one or more floating-point units may include resources for performing floating-point operations. In some embodiments, the resources of the one or more floating-point units are operable to perform SIMD floating-point operations.

In one set of embodiments, the execution units 526-1 through 526-N include one or more SIMD units configured for performing integer and/or floating point SIMD operations.

As illustrated by FIG. 5, the execution units 526-1 through 526-N and load/store unit 430 may couple to dispatch bus 519 and results bus 536. The execution units 526-1 through 526-N and load/store unit 530 receive ops from the FDS unit 518 via the dispatch bus 519, and pass the results of execution to register file 538 via results bus 536. The one or more additional units (such as GEU 550, JBU 554, MCU 558 and EDU 562) receive ops from FDS unit 522 via dispatch bus 523, interface 534 and request router 510, and send information indicating the completion of each op execution to the interface 534 via the request router 510.

The register file 538 couples to feedback path 546, which allows data from the register file 538 to be supplied as source operands to the execution units (including execution units 526-1 through 526-N, load/store unit 530, and the one or more additional execution units).

Bypass path 544 couples between results bus 536 and feedback path 544, allowing the results of execution to bypass the register file 538, and thus, to be supplied as source operands to the execution units more directly. Register file 538 may include physical storage for a set of architected registers.

In some embodiments, the FDS unit 522 is configured to dispatch ops to execution units 456-1 through 526-N (or some subset of those units) in addition to the one or more additional execution units and load/store unit 530. Thus, dispatch bus 523 may couple to one or more of the execution units 526-1 through 526-N in addition to load/store unit 530 and interface 534.

As noted above, the execution units 526-1 through 526-N may include one or more floating-point units. Each floating-point unit may be configured to execute floating-point instructions (e.g., x87 floating-point instructions, or floating-point instructions compliant with IEEE 754/854). Each floating-point unit may include an adder unit, a multiplier unit, a divide/square-root unit, etc. Each floating-point unit may operate in a coprocessor-like fashion, in which FDS unit 518 directly dispatches the floating-point instructions to the floating-point unit.

As described above, in some embodiments, the processor 500 supports the processor instruction set P and the second instruction set Q. It is noted that the instructions of processor instruction set P and the instructions of the second instruction set Q address the same memory space. Thus, it is easy for a programmer to build a first program thread using P instructions and a second program thread using Q instructions where the two threads communicate quickly through system memory or internal registers (i.e., registers of the register file 538). Because the threads are executed on a single processor (i.e., processor 500), there is no need to invoke the facilities of the operating system in order to communicate between two threads.

In one embodiment, processor 500 may be configured on a single integrated circuit. In another embodiments, processor 500 may include a plurality of integrated circuits. For example, the one or more additional execution units may be realized in one or more integrated circuits.

As described above, in some embodiments, any (or all) of processors 100, 200, 300 and 400 may include a graphics execution unit (GEU) capable of executing instructions conforming to a given version of an industry-standard graphics API such as DirectX. Subsequent updates to the API standard may be implemented in software. (This is to be contrasted with the costly traditional practice of redesigning graphics accelerators and their on-board GPUs to support new versions of graphics APIs.)

In some embodiments of processors 100, 200, 300 and 400, instructions and data are stored in the same memory. In other embodiments, they are stored in different memories.

### Graphics Execution Unit

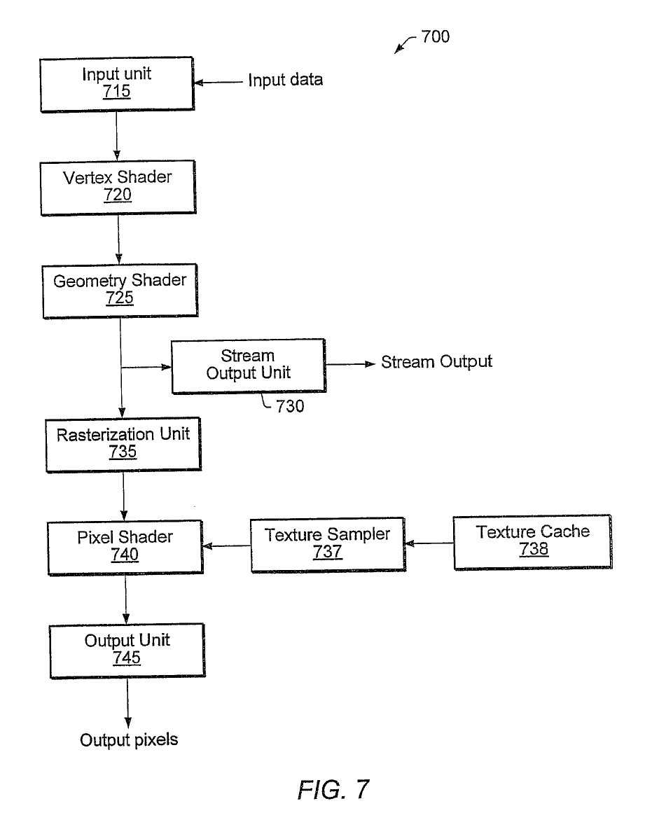

The various above-described embodiments of the graphics execution unit (e.g., GEU 130, GEU 250, GEU 450 and GEU 550) may be realized by GEU 700 of FIG. 7. GEU 700 is configured to receive the instructions of the graphics instruction set and to perform graphics operations in response to receiving the graphics instructions. In one embodiment, GEU 700 is organized as a pipeline that includes an input unit 715, a vertex shader 720, a geometry shader 720, a rasterization unit 735, a pixel shader 740, and an output/merge unit 745. The GEU 700 may also include a stream output unit 730.

The input unit 715 is configured to receive a stream of input data and assemble the data into graphics primitives (such as triangles, lines and points) as determined by the received graphics instructions. The input unit 715 supplies the graphics primitives to the rest of the graphics pipeline.

The vertex shader 720 is configured to operate on vertices as determined by the received graphics instructions. For example, the vertex shader 720 may be programmed to perform transformations, skinning, and lighting on vertices. In some embodiments, the vertex shader 720 produces a single output vertex for each input vertex supplied to it. In some embodiments, the vertex shader 720 is configured to receive one or more vertex shader programs supplied as part of the received graphics instructions and to execute the one or more vertex shader programs on vertices.

The geometry shader 725 processes whole primitives (e.g., triangles, lines or points) as determined by the received graphics instructions. For each input primitive, the geometry shader can discard the input primitive or generate one or more new primitives as output. In one embodiment, the geometry shader is also configured to perform geometry amplification and de-amplification. In some embodiments, the geometry shader 725 is configured to receive one or more geometry shader programs as part of the received graphics instructions and to execute the one or more geometry shader programs on primitives.

The stream output unit 730 is configured for outputting primitive data as a stream from the graphics pipeline to system memory. This output feature is controlled by the received graphics instructions. The data stream sent to memory can be returned to the graphics pipeline as input data (if so desired).

The rasterization unit 735 is configured to receive primitives from geometry shader 725 and to rasterize the primitives into pixels as determined by the graphics instructions. Rasterization involves interpolating selected vertex components at pixel positions across the given primitive. Rasterization may also include clipping the primitives to the view frustum, performing a perspective divide operation, and mapping vertices to the viewport.

The pixel shader unit 740 generates per-pixel data (such as color) for each pixel in a given primitive. For example, the pixel shader 740 may apply per-pixel lighting. In some embodiments, the pixel shader unit 740 is configured to receive one or more pixel shader programs as part of the received graphics instructions and to execute the one or more pixel shader programs per pixel. The rasterization unit may invoke execution of the one or more pixel shader programs as part of the rasterization process.

The output unit 745 is configured to combine one or more types of output data (e.g., pixel shader values, depth information and stencil information) with the contents of a target buffer and the depth/stencil buffers to produce the final pipeline output.

In some embodiments, the GEU 700 also includes a texture sampler 737 and a texture cache 738. The texture sampler 737 is configured to access texel data from system memory via texture cache 738 and to perform texture interpolation on the texel data (e.g., MIP MAP data) to support texture mapping. The interpolated data generated by the texture sampler may be provided to the pixel shader 740.

In some embodiments, the GEU 700 may be configured for parallel operation. For example, the GEU 700 may be pipelined in order to more efficiently operate on streams of vertices, streams of primitives, and streams of pixels. Furthermore, various units within the GEU 700 may be configured to operate on vector operands. For example, in one embodiment, the GEU 700 may support 64-element vectors, where each element is a single-precision floating-point (32 bit) quantity.

### Multiple Cores

Any of the processor embodiments described herein may be configured with a plurality of cores. For example, processor 100 may include a plurality of cores, each including the elements shown in FIG. 1. Each core may have its own dedicated texture memory and L1 cache. Processors 200, 300 and 400 may be similarly configured with a plurality of cores. With a multi-core architecture, future improvements in performance may be attained simply by increasing the number of cores in the processor.

In any of the multi-core embodiments, it is possible for one or more of the cores within a processor to be defective due to flaws in manufacturing. Thus, the processor may include logic that disables any cores within the processor that are determined to be defective so that the processor may operate with the remaining “good” cores.

It is noted that, in some embodiments, mutiple cores in the multi-core implementation may share a common set of one or more coprocessors.

In some embodiments, load balancing between general-purpose processing and graphics rendering may be achieved on a multi-threaded multi-core processor by balancing the number of threads that are running general-purpose processing tasks versus the number of threads that are running graphics rendering tasks. Thus, the programmer may have more explicit control of the load balancing. Since multi-threaded software design may tend to decrease the number of opportunities for OOO processing, each core may be configured with a reduced OOO-processing complexity compared to processors such as the Opteron processors produced by AMD. Each core may be configured to switch between a plurality of threads. The thread switching tends to hide memory and instruction access latency.

In some embodiments, RAM internal to the processor or cache memory locations (L1 cache locations) internal to the processor may be mapped to some portion of the memory space in order to facilitate communication between cores. Thus, a thread running on one core may write to an address in a reserved address range. The write data would then be stored into the corresponding RAM location or cache memory location. Another thread running on another core (or perhaps on the same core) could then read from that same address. Thus, communication between threads and between cores may be achieved without the long latency associated with accesses to system memory.

In some embodiments, communication between threads within a multi-core processor may be achieved using a set of non-memory-mapped locations that are internal to the processor and that behave like a FIFO. The instruction set would then include a number of instructions, each of which relies on the FIFO as its implied source or target. For example, the instruction set may include a load instruction that implicitly specifies loading data from the FIFO. If the FIFO is currently empty the current thread may be suspended or a trap may be asserted. Similarly, the instruction set may include a store instruction that implicitly specifies storing data to the FIFO. If the FIFO is currently full the current thread may be suspended or a trap may be asserted.

What is claimed is:

1. A processor comprising:
a plurality of execution units;
a graphics execution unit (GEU); and
a first unit coupled to the GEU and the plurality of execution units and configured to fetch a stream of instructions, wherein the stream of instructions includes first instructions conforming to a processor instruction set and second instructions for performing graphics operations, wherein the second instructions include at least one instruction for performing pixel shading on pixels, wherein the first unit is configured to: decode the first instructions and the second instructions; schedule execution of at least a subset of the decoded first instructions on the plurality of execution units; and schedule execution of at least a subset of the decoded second instructions on the GEU.

2. The processor of claim 1, wherein the first instructions and the second instructions address the same memory space.

3. The processor of claim 1 further comprising: an interface unit and a request router, wherein the interface unit is configured to forward the decoded second instructions to the GEU via the request router, wherein the GEU is configured to operate in coprocessor fashion.

4. The processor of claim 1, wherein the second instructions include an instruction for performing geometry shading on geometric primitives.

5. The processor of claim 1, wherein the second instructions include an instruction for performing pixel shading on geometric primitives.

6. The processor of claim 1 further comprising: a second execution unit, wherein the stream of instructions also includes Java bytecode, wherein the first unit is configured to schedule execution of the Java bytecode on the second execution unit.

7. The processor of claim 1, further comprising: a second execution unit, wherein the stream of instructions also includes managed code, wherein the first unit is configured to schedule execution of the managed code on the second execution unit.

8. The processor of claim 1, wherein the GEU includes a vertex shader, a geometry shader, a rasterizer, a pixel shader, and a unified shader.

9. A processor comprising:
a plurality of first execution units;
one or more second execution units;
a third unit coupled to the plurality of first execution units and configured to fetch a first stream of instructions, wherein the first stream of instructions includes first instructions conforming to a processor instruction set, wherein the third unit is configured to decode the first instructions and schedule execution of at least a subset of the decoded first instructions on the plurality of execution units; and
a fourth unit coupled to the one or more second execution units and configured to fetch a second stream of instructions, wherein the second stream of instructions includes second instructions conforming to a second instruction set different from the processor instruction set, wherein the fourth unit is configured to decode the second instructions and schedule execution of at least a subset of the decoded second instructions on the one or more second execution units.

10. The processor of claim 9, wherein the first instructions and the second instructions address the same memory space.

11. The processor of claim 9 further comprising: an interface unit and a request router, wherein the interface unit is configured to forward the decoded second instructions to the one or more second execution units via the request router, wherein the one or more second execution units are configured to operate as coprocessors.

12. The processor of claim 9, wherein the second instructions include an instruction for performing geometry shading on geometric primitives.

13. The processor of claim 9, wherein the second instructions include an instruction for performing pixel shading on pixels.

14. The processor of claim 9, wherein second instructions are Java bytecode.

15. The processor of claim 9, wherein the second instructions are managed code.

16. The processor of claim 9, wherein a first of the one or more second execution units includes a vertex shader, a geometry shader, a pixel shader, and a unified shader.

17. A processor comprising:
a plurality of first execution units;
one or more second execution units; and
a control unit coupled to the plurality of first execution units and the one or more second execution units and configured to fetch a stream of instructions, wherein the stream of instructions includes first instructions conforming to a processor instruction set and second instructions conforming to a second instruction set different from the processor instruction set, wherein the control unit is further configured to decode the first instructions, schedule execution of at least a subset of the decoded first instructions on the plurality of first execution units, decode the second instructions, and schedule execution of at least a subset of the decoded second instructions on the one or more second execution units.

18. The processor of claim 17, wherein the first instructions and the second instructions address the same memory space.

19. The processor of claim 17 further comprising: an interface unit and a request router, wherein the interface unit is configured to forward the decoded second instructions to the one or more second execution unit via the request router, wherein the one or more second execution units are configured to operate in coprocessor fashion.

20. The processor of claim 17, wherein at least one of the second execution units includes a vertex shader, a geometry shader, a rasterizer, a pixel shader, and a unified shader.
